(19) United States
(12) Patent Application Publication
(10) Pub. No.: US 2009/0239040 A1
(43) Pub. Date: Sep. 24, 2009

(54) METHOD FOR MANUFACTURING MOLDED ARTICLE

(75) Inventors: Zheng Shi, Shenzhen City (CN); Chih-Chiang Chang, Taipei Hsien (TW)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/164,260

(22) Filed: Jun. 30, 2008

(30) Foreign Application Priority Data
Mar. 19, 2008 (CN) 200810300631.X

(51) Int. Cl. B32B 3/00; B29C 65/00

(52) U.S. Cl. 428/172; 156/196

(57) ABSTRACT

A method for manufacturing a molded article (10) is provided. is provided. The method includes steps as follows. A substrate (11) and a textured layer (12) are molded and the textured layer is formed on the substrate. A leather coating layer (13) is coated on the substrate and the leather coating layer is mixed with the textured layer.

### BACKGROUND OF THE INVENTION

1. Field of the Invention

The present invention relates to manufacturing methods, particularly to a method for manufacturing a molded article.

2. Description of Related Art

Molded articles, such as molded shells, are widely used in many technological fields. One example is a molded shell used with a portable electronic device (e.g., a mobile phone) for containing internal electronic components. Another example is a molded shell used with a piece of furniture (e.g., a mini sofa) to provide decoration.

Typically, In-Mold Lamination (IML) technology is used to manufacture a molded shell with a leather appearance. During process of manufacturing, a piece of leather is placed in a mold for in-mold laminating to achieve the molded shell with the leather appearance. However, at least because leather has low resistance to high temperatures, the piece of leather can be damaged during manufacturing. Thereby, quality is decreased. In addition, during the molding process, the leather pieces tend to be damaged (e.g., scraped) by improper/imprecise mold design. Therefore, again, quality is decreased.

Therefore, a need exists in the art to address these deficiencies and inadequacies.

### BRIEF DESCRIPTION OF THE DRAWINGS

Many aspects of the present molded article manufactured by the present method can be better understood with reference to the following drawing. This drawing is not necessarily drawn to scale, the emphasis instead being placed upon clearly illustrating the principles of the present molded article. Moreover, in the drawing like reference numerals designate corresponding parts throughout the view. Wherever possible, the same reference numbers are used throughout the drawing to refer to the same or like elements of an embodiment.

FIG. 1 is a top plan view of a molded article manufactured by a method according to an exemplary embodiment.

FIG. 2 is a cross-sectional view of the molded article of FIG. 1.

### DETAILED DESCRIPTION OF THE EXEMPLARY EMBODIMENTS

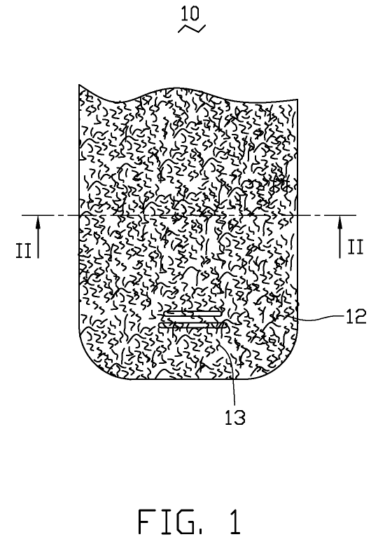

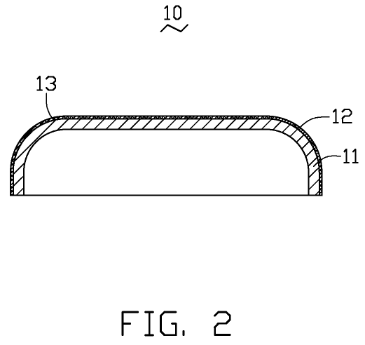

Referring to FIGS. 1 and 2, the molded shell 10 includes a substrate 11, having a textured surface 12, and a leather coating layer 13. The leather coating layer 13 covers the textured surface 12.

The substrate 11 can be formed by injection molding materials, such as plastics, rubbers, or silicons. The plastics can be one or more plastics selected from a group consisting of PVC (i.e., polyvinyl chloride), ABS (i.e., acrylonitrile-butadiene-styrene), PC (i.e., polycarbonate), polystyrene, polypropylene, and polyurethane.

A conventional injection mold (not shown) is provided for manufacturing the molded shell 10 and typically includes a core insert and a mold cavity. The core insert has a textured surface corresponding to the textured surface 12 on the substrate 11. The textured surface can be attained by chemical etching or discharging etching.

During manufacturing, the core insert mates with the mold cavity to mold the substrate 11 therein. The textured surface 12 is formed on an exterior surface of the substrate 11. The textured surface 12 has substantially the same shape and size as that of the textured surface of the core insert. Finally, the leather coating layer 13 is formed/coated on the textured surface 12 by a conventional coating method.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a molded article, comprising the steps of:
molding a substrate and forming a textured surface on the substrate; and
coating a leather coating layer on the substrate, the leather coating layer covering the textured surface.

2. The method as claimed in claim 1, wherein the substrate is molded using at least one material selected from a group consisting of: plastics, rubbers, and silicons.

3. The method as claimed in claim 2, wherein the plastic is selected from a group consisting of: polyvinyl chloride, acrylonitrile-butadiene-styrene, polycarbonate, polystyrene, polypropylene, and polyurethane.

4. A molded article manufactured by a method as claimed in claim 1, comprising:
a substrate;
a textured layer formed on the substrate; and
a leather coating layer coated on the substrate, the leather coating layer mixed with the textured layer.

5. The molded article as claimed in claim 4, wherein the substrate is molded by one or more materials selected from a group consisting of plastic materials, rubber materials, and silicon materials.

6. The molded article as claimed in claim 5, wherein the plastic material is one material selected from a group consisting of a polyvinyl chloride material, an acrylonitrile-butadiene-styrene material, a polycarbonate material, a polystyrene material, a polypropylene material, and a polyurethane material.
